(19) United States
(12) Patent Application Publication
(10) Pub. No.: US 2008/0012631 A1
(43) Pub. Date: Jan. 17, 2008

(54) BIAS CURRENT GENERATION CIRCUIT AND METHOD THEREOF

(76) Inventor: Chia-Jun Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/762,762

(22) Filed: Jun. 13, 2007

(30) Foreign Application Priority Data
Jun. 23, 2006 (TW) 095122652

(51) Int. Cl. G05F 1/10

(52) U.S. Cl. 327/543

(57) ABSTRACT

The present invention discloses a bias current generation circuit for generating a bias current required by a low voltage domain circuit. The bias current generation circuit includes a high voltage domain current generation circuit and a current converting circuit. The high voltage domain current generation circuit generates a first current. The current converting circuit is coupled to the high voltage domain current generation circuit and the low voltage domain circuit and generates the bias current according to the first current. The high voltage domain current generation circuit is powered by a first supply voltage, while the current converting circuit and the low voltage domain circuit are powered by a second supply voltage. The voltage level of the first supply voltage is higher than the voltage level of the second supply voltage.

### BACKGROUND OF THE INVENTION

1. Field of the Invention

The present invention relates to a method for generating a bias current required by an electronic circuit, and more particularly, to a bias current generation circuit for generating a bias current required by a low voltage domain circuitry and method thereof.

2. Description of the Prior Art

Considering the issues of power consumption and degree of circuit integration of an integrated circuit (IC), it is common practice for an operating voltage, or power supply voltage, used by core circuitry of the IC, to be lower than one used by peripheral circuitry of the IC. Generally speaking, the core circuit of the IC operates under a lower supply voltage, and therefore is termed as low voltage domain circuit. The majority of the transistors in the core circuit are usually fabricated with thinner oxide layer, which can endure less cross voltage level, and therefore are termed as low voltage devices. Contrastingly, the peripheral circuit of the IC, which is external to the core circuit, operates under a higher supply voltage, and therefore is termed as high voltage domain circuit. The majority of the transistors in the peripheral circuit are usually fabricated with thicker oxide layer, which can endure more cross voltage level, and therefore are termed as high voltage devices. Taking TSMC's 0.18 μm IC manufacturing process as an example, the nominal supply voltages for the high voltage domain circuit and for the low voltage domain circuit are respectively 3.3 V and 1.8 V, and the standard thickness of the oxide layer of a high voltage device and that of a low voltage device are respectively 7 nm and 4 nm.

Almost all analog circuits make use of bias currents. For an analog core circuit, the bias current(s) required by the analog core circuit can be generated from a bias circuit in the low voltage domain circuit. By so implementing, it becomes easy to achieve the goal of cutting off supply of the bias current by breaking a path providing said bias current when the bias current is not needed in the low voltage domain circuit, for example, when the low voltage domain circuit does not need to function. However, this scheme of directly using the bias circuit in the low voltage domain circuit itself for the purpose of supplying the low voltage domain circuit may run into problems, such as resulting in dead lock. More specifically, in case of insufficient driving ability of the bias circuit in the low voltage domain circuit, it becomes very likely that the low voltage domain circuit cannot escape a meta-stable point and therefore dead clock occurs.

Another scheme exists which utilizes the high voltage domain circuit to directly provide the low voltage domain circuit with a bias current. However, by using this scheme, where the low voltage domain circuit is directly coupled to the high voltage domain circuit for receiving the bias current provided by the high voltage domain circuit, the circuit components in the low voltage domain circuit may operate under an intolerably high voltage level and therefore may be permanently damaged. This drastically reduces the reliability of the whole IC. Additionally, a switch implemented by a low voltage device is usually used for controlling a path leading the bias current provided by the high voltage domain circuit into the low voltage domain circuit. The switch is turned on if the bias current is needed in the low voltage domain circuit; otherwise, the switch is turned off. However, since one end of the switch is directly coupled to the high voltage domain circuit, a voltage drop across the two ends of the switch may be so high that the switch will crash. Even with the switch turned off, a leakage current passing through the switch may still exist since the voltage drop across the two ends of the switch is high. It is therefore not the optimal solution that the high voltage domain circuit is used for directly providing the low voltage domain circuit with a required bias current.

### SUMMARY OF THE INVENTION

One of the objectives of the present invention is to provide a bias current generation circuit and method thereof, which may solve the above-mentioned problem.

According to an embodiment of the present invention, a bias current generation circuit utilized for generating a bias current required by a low voltage domain circuit is disclosed. The bias current generation circuit comprises a high voltage domain current generation circuit and a current converting circuit. The high voltage domain current generation circuit is utilized for generating a first current. The current converting circuit is coupled to the high voltage domain current generation circuit and the low voltage domain circuit, and is utilized for generating the bias current according to the first current. The high voltage domain current generation circuit is powered by a first supply voltage, while the current converting circuit and the low voltage domain circuit are powered by a second supply voltage. The voltage level of the first supply voltage is higher than the voltage level of the second supply voltage.

According to another embodiment of the present invention, a bias current generation method for generating a bias current required by the low voltage domain circuit is disclosed. The bias current generation method comprises: generating a first current by a power supplied by a first supply voltage; and generating the bias current by a power supplied by a second supply voltage according to the first current. The low voltage domain circuit is powered by the second supply voltage, and a voltage level of the first supply voltage is higher than a voltage level of the second supply voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a bias current generation circuit according to an embodiment of the present invention.

### DETAILED DESCRIPTION

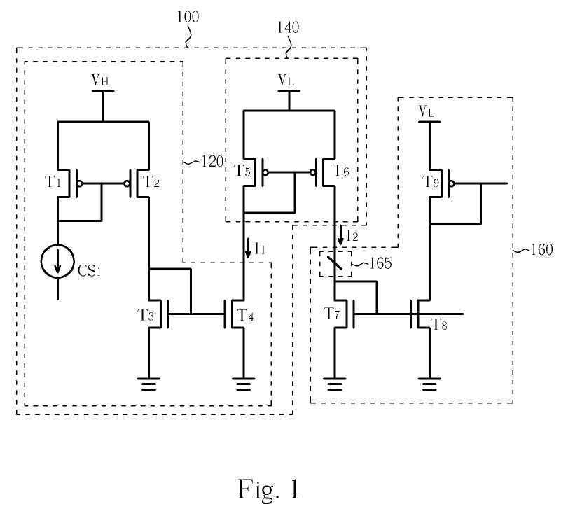

FIG. 1 is a diagram illustrating a bias current generation circuit 100 according to an embodiment of the present invention. In this embodiment, the bias current generation circuit 100 is utilized for generating a bias current 12 required by a low voltage domain circuit 160. As shown in FIG. 1, the bias current generation circuit 100 comprises a high voltage domain current generation circuit 120 and a current converting circuit 140. The high voltage domain current generation circuit 120 operates under a high voltage level; that is, the high voltage domain current generation circuit 120 is powered by a first supply voltage V_{H} with a higher voltage level. The current converting circuit 140 and low voltage domain circuit 160 both operate under a low voltage level; that is, the current converting circuit 140 and low voltage domain circuit 160 are both powered by a second supply voltage V_{L} with a lower voltage level. In other words, a voltage level of the first supply voltage V_{H} is higher than a voltage level of the second supply voltage V_{L}. Additionally, the thickness of the oxide layer of the transistors in the high voltage domain current generation circuit 120 (e.g., the transistors T₁, T₂, T₃, and T₄) is thicker than the oxide layer of the transistors in the current converting circuit 140 and in the low voltage domain circuit 160 (e.g., the transistors T₅, T₆, T₇, T₈, and T₉).

Taking TSMC's 0.18 μm IC manufacturing process as an example, the voltage level of the first supply voltage V_{H} is designated 3.3V and the voltage level of the second supply voltage V_{L} is designated 1.8V. The thickness of the oxide layer of each of the transistors T₁, T₂, T₃, and T₄ is designated 7 nm and the thickness of the oxide layer of each of the transistors T₅, T₆, T₇, T₈, and T₉ is designated 4 nm. However, the adoption of these values should not serve as a limitation of the present invention.

In this embodiment, the high voltage domain current generation circuit 120 generates a first current I₁ by the electrical energy provided by the first supply voltage V_{H}. As shown in FIG. 1, the high voltage domain current generation circuit 120 comprises a current source CS₁ and two sets of current mirrors. One current mirror is composed of the transistors T₁, T₂, and the other current mirror is composed of the transistors T₃, T₄. In other embodiments, however, the composition of the high voltage domain current generation circuit 120 can be replaced with other components and configurations known or novel to a person of ordinary skill in the pertinent art; in other words, any current generation circuit powered by the first supply voltage V_{H} for generating the first current I₁ falls within the scope of the present invention. As a result, one skilled in this art can easily utilize different schemes for accomplishing the function and operation of the high voltage domain current generation circuit 120 according to the spirit of the present invention.

The current converting circuit 140, powered by the second supply voltage V_{L}, is used for generating a bias current 12 required by the low voltage domain circuit 160 according to the first current I₁. To achieve the goal of current conversion of this sort, the current converting circuit 140 is implemented with a low voltage domain current mirror having the transistors T₅ and T₆, which mirrors the first current I₁ and then generates the bias current I₂ required by the low voltage domain circuit 160. Usually, the low voltage domain circuit 160 is the core circuit within an integrated circuit (IC). Although only the switch 165 and the transistors T₇, T₈, T₉ for duplicating the bias current I₂ are shown in FIG. 1, in practice the low voltage domain circuit 160 may also comprise other circuits for generating bias currents by current mirrors.

When the bias current I₂ is needed by the low voltage domain circuit 160, the switch 165 is turned on; otherwise, when the bias current 12 is not needed by the low voltage domain circuit 160, the switch 165 is turned off. Generally, the switch 165 can be implemented with a low voltage transistor (i.e., a transistor that is a low voltage device). Since the low voltage domain circuit 160 is not directly connected to the high voltage domain current generation circuit 120, the devices in the low voltage domain circuit 160 never operate under an intolerably high voltage level, and therefore will not crash and will be permanently damaged. As a result, the reliability of the whole IC becomes higher. Moreover, because the switch 165 is not directly connected to the high voltage domain current generation circuit 120, the voltage drop across the switch 165 is not overly high no matter the switch 165 is turned on or off, and therefore the likelihood of damaging the switch is greatly reduced. Additionally, since the voltage drop across the switch 165 is not overly high, no leakage current results when the switch 165 is turned off. Because the high voltage domain current generation circuit 120 shows sufficient driving ability, by using the high voltage domain current generation circuit 120 to generate the initial first current I₁ and then using the current converting circuit 140 to generate, according to the first current I₁, the bias current I₂ required by the low voltage domain circuit 160, it is guaranteed that the low voltage domain circuit 160 can successfully escape the meta-stable point, and a dead lock situation can be avoided.

It should be noted that, in the above embodiments, the current mirror in the current converting circuit 140 is formed with the transistors T₅, T₆ being implemented with low voltage devices having thinner oxide layer. However, this is not meant to be limiting. In another embodiment, the transistors T₅, T₆ can be implemented with high voltage devices having thicker oxide layer. However, when using low voltage devices to implement the transistors T₅, T₆, they will operate in a low voltage domain; that is, the transistors T₅, T₆ are to be powered by the second supply voltage V_{L} having a lower voltage level. Furthermore, although the action of breaking the second current I₂, or effectively the power supply effectuated by it, away from the low voltage domain circuit 160 is achieved by introducing the switch 165 between the drain of the transistor T₆ and the drain of the transistor T₇ in the above-mentioned embodiment, the present invention is not limited thereto. Adopting other switching mechanism at the same or other portion of the circuitry may also achieve the same goal. For example, in one embodiment a switch can be inserted between the drain and the gate of the transistor T₇, substituting the adoption of the switch 165, which switch, when turned off, effectively disables the power supply to the low voltage domain circuit 160 by nullifying the current mirror effect between the transistor T₇ and the transistor T₈.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A bias current generation circuit for generating a bias current required by a low voltage domain circuit, the bias current generation circuit comprising:
a high voltage domain current generation circuit, for generating a first current; and
a current converting circuit, coupled to the high voltage domain current generation circuit and the low voltage domain circuit, for generating the bias current according to the first current;
wherein the high voltage domain current generation circuit is powered by a first supply voltage; the current converting circuit and the low voltage domain circuit are powered by a second supply voltage; and a voltage level of the first supply voltage is higher than a voltage level of the second supply voltage.

2. The bias current generation circuit of claim 1, wherein a thickness of an oxide layer of a transistor in the high voltage domain current generation circuit is thicker than a thickness of an oxide layer of a transistor in the current converting circuit; and the thickness of the oxide layer of the transistor in the high voltage domain current generation circuit is thicker than a thickness of an oxide layer of a transistor in the low voltage domain circuit.

3. The bias current generation circuit of claim 1, wherein a thickness of an oxide layer of a transistor in the high voltage domain current generation circuit is thicker than a thickness of an oxide layer of a transistor in the low voltage domain circuit; and a thickness of an oxide layer of a transistor in the current converting circuit is thicker than the thickness of the oxide layer of the transistor in the low voltage domain circuit.

4. The bias current generation circuit of claim 1, wherein the current converting circuit comprises:
a low voltage domain current mirror, coupled to the high voltage domain current generation circuit and the low voltage domain circuit, for generating the bias current by mirroring the first current.

5. The bias current generation circuit of claim 1, wherein the low voltage domain circuit comprises:
a switch, coupled to the current converting circuit, for receiving the bias current or for enabling a current mirror configuration of the low voltage domain circuit to receive the bias current.

6. The bias current generation circuit of claim 1, wherein when the bias current is required by the low voltage domain circuit, the switch is turned on for transmitting the bias current to the low voltage domain circuit; and when the bias current is not required by the low voltage domain circuit, the switch is turned off.

7. A bias current generation method for generating a bias current required by a low voltage domain circuit, the bias current generation method comprising:
generating a first current by a power provided by a first supply voltage; and
generating the bias current by a power provided by a second supply voltage according to the first current;
wherein the low voltage domain circuit is powered by the second supply voltage; and a voltage level of the first supply voltage is higher than a voltage level of the second supply voltage.

8. The bias current generation method of claim 7, wherein the step of generating the bias current by the power provided by the second supply voltage according to the first current comprises:
mirroring the first current to generate the bias current by the power provided by the second supply voltage.

9. The bias current generation method of claim 7, further comprising:
when the bias current is required by the low voltage domain circuit, turning on a switch for transmitting the bias current to the low voltage domain circuit; and
when the bias current is not required by the low voltage domain circuit, turning off the switch.
